(19) United States
(12) Patent Application Publication
(10) Pub. No.: US 2013/0335743 A1
(43) Pub. Date: Dec. 19, 2013

(54) Inspection Device for Glass Substrate Cassette

(71) Applicants: Xiande Li, Shenzhen (CN); Chunhao Wu, Shenzhen (CN); Kunhsien Lin, Shenzhen (CN); Minghu Qi, Shenzhen (CN); Zenghong Chen, Shenzhen (CN); Yongqiang Wang, Shenzhen (CN); Weibing Yang, Shenzhen (CN); Zhenhua Guo, Shenzhen (CN); Yunshao Jiang, Shenzhen (CN); Zhiyou Shu, Shenzhen (CN)

(72) Inventors: Xiande Li, Shenzhen (CN); Chunhao Wu, Shenzhen (CN); Kunhsien Lin, Shenzhen (CN); Minghu Qi, Shenzhen (CN); Zenghong Chen, Shenzhen (CN); Yongqiang Wang, Shenzhen (CN); Weibing Yang, Shenzhen (CN); Zhenhua Guo, Shenzhen (CN); Yunshao Jiang, Shenzhen (CN); Zhiyou Shu, Shenzhen (CN)

(73) Assignee: SHENZHEN CHINA STAR OPTOELECTRONICS TECHNOLOGY CO. LTD., Shenzhen (CN)

(21) Appl. No.: 13/575,925

(22) PCT Filed: Jun. 21, 2012
(86) PCT No.: PCT/CN12/77321

§ 371 Date: Jul. 27, 2012

(30) Foreign Application Priority Data
Jun. 19, 2012 (CN) 201210203237.0

(51) Int. Cl. G01N 21/17

(52) U.S. Cl. 356/432

(57) ABSTRACT

The present invention provides an inspection device for glass substrate cassette. Glass substrate cassette is disposed vertically with a plurality of support surfaces for supporting glass substrate. The inspection device includes a plurality of inspection units, vertically disposed and corresponding to the plurality of support surfaces to perform inspection simultaneously on each support surface whether a glass substrate is loaded on corresponding support surface, and whether an abnormal situation of glass substrate has occurred. The present invention includes a plurality of inspection units disposed vertically to perform inspection simultaneously on each support surface disposed vertically in cassette, and reduces the inspection time.

### BACKGROUND OF THE INVENTION

1. Field of the Invention

The present invention relates to the field of inspection device, and in particular to an inspection device for glass substrate cassette.

2. The Related Arts

Glass substrates for display panels of TV display or TV are temporarily stored in cassette before entering manufacture process. The cassette is usually disposed with a plurality of support surfaces vertically, with each support surface supporting a glass substrate.

During the period from glass substrate loaded into cassette for temporary storage to automatic storage and retrieval system (AS/RS) moving cassette to display panel manufacture processing line, the cassette must be inspected whether each support surface in the cassette is loaded with a glass substrate and whether double-loading, i.e., two substrates loaded on a support surface, has occurred. A know inspection device includes a transducer unit and a control unit. The transducer unit includes a light-emitting part and a light-receiving part. The control unit includes a transducer unit control module. The light-emitting part is for emitting inspection light. The inspection light is reflected by the glass substrate, and the reflected light is received by light-receiving part. The transducer unit converts the light signal into electrical signal and transmits to the transducer unit control module of control unit for inspection whether a glass substrate is loaded on corresponding support surface, and whether a double-loading has occurred.

During the inspection, the inspection device must follow a specific order to inspect each support surface of cassette; thus, the efficient and productivity are low, and manufacture is delayed.

### SUMMARY OF THE INVENTION

The technical issue to be addressed by the present invention is to provide an inspection device for glass substrate cassette, able to perform fast inspection of information on glass substrates loaded in cassette.

The present invention provides an inspection device for glass substrate cassette. Glass substrate cassette is disposed vertically with a plurality of support surfaces for supporting glass substrate. The inspection device comprises a plurality of inspection units, vertically disposed and corresponding to the plurality of support surfaces to perform inspection simultaneously on each support surface whether a glass substrate is loaded on corresponding support surface, and whether a double-loading has occurred. Each inspection unit comprises a light-projecting part and a light-receiving part. The light-projecting part is for projecting inspection light to inspection location on corresponding support surface, and the light-receiving part is for receiving inspection light reflected by inspection location. Inspection device further comprises a processing unit, for judging whether reflected inspection light is within a predefined range. The inspection device further comprises a fix element, for fixing plurality of inspection units along vertical direction.

According to a preferred embodiment of the present invention, the fix element is located on the outer side of the cassette.

According to a preferred embodiment of the present invention, the cassette is disposed with at least two sets of plurality of support surfaces along the horizontal direction, and the inspection device further comprises at least a horizontal slide track, with fix element slidably fixed to the horizontal slide track so that a plurality of inspection units is able to inspect each set of plurality of support surfaces sequentially.

According to a preferred embodiment of the present invention, the inspection device further comprises a drive motor, for driving fix element to slide along horizontal slide track.

According to a preferred embodiment of the present invention, number of horizontal slide tracks is two, and two horizontal slide tracks are disposed in parallel and within same vertical plane.

According to a preferred embodiment of the present invention, the cassette is disposed with at least two sets of plurality of support surfaces along the horizontal direction, and the inspection device further comprises a rotation support device, with fix element supported by the rotation support device and able to rotate around vertically disposed rotation axis so that a plurality of inspection units is able to inspect each set of plurality of support surfaces sequentially.

According to a preferred embodiment of the present invention, the rotation support device simultaneously supports top and bottom of fix element along vertical direction.

According to a preferred embodiment of the present invention, the inspection device further comprises a drive motor, for driving fix element to rotate around rotation axis.

The efficacy of the present invention is that to be distinguished from the state of the art. The inspection device for glass substrate cassette according to the present invention comprises a plurality of inspection units disposed vertically so as to simultaneously perform inspection on a plurality of support surfaces of cassette disposed vertically. The inspection time is reduced, and efficiency and productivity are improved.

The present invention provides an inspection device for glass substrate cassette. Glass substrate cassette is disposed vertically with a plurality of support surfaces for supporting glass substrate. The inspection device comprises a plurality of inspection units, vertically disposed and corresponding to the plurality of support surfaces to perform inspection simultaneously on each support surface whether a glass substrate is loaded on corresponding support surface, and whether an abnormal situation of glass substrate has occurred.

According to a preferred embodiment of the present invention, each inspection unit comprises a light-projecting part and a light-receiving part. The light-projecting part is for projecting inspection light to inspection location on corresponding support surface, and the light-receiving part is for receiving inspection light reflected by inspection location, and the inspection device further comprises a processing unit, for judging whether reflected inspection light is within a predefined range.

According to a preferred embodiment of the present invention, the inspection device further comprises a fix element, for fixing plurality of inspection units along vertical direction.

According to a preferred embodiment of the present invention, the fix element is located on the outer side of the cassette.

According to a preferred embodiment of the present invention, the cassette is disposed with at least two sets of plurality of support surfaces along the horizontal direction, and the inspection device further comprises at least a horizontal slide track, with fix element slidably fixed to the horizontal slide track so that a plurality of inspection units is able to inspect each set of plurality of support surfaces sequentially.

According to a preferred embodiment of the present invention, the inspection device further comprises a drive motor, for driving fix element to slide along horizontal slide track.

According to a preferred embodiment of the present invention, number of horizontal slide tracks is two, and two horizontal slide tracks are disposed in parallel and within same vertical plane.

According to a preferred embodiment of the present invention, the cassette is disposed with at least two sets of plurality of support surfaces along the horizontal direction, and the inspection device further comprises a rotation support device, with fix element supported by the rotation support device and able to rotate around vertically disposed rotation axis so that a plurality of inspection units is able to inspect each set of plurality of support surfaces sequentially.

According to a preferred embodiment of the present invention, the rotation support device simultaneously supports top and bottom of fix element along vertical direction.

According to a preferred embodiment of the present invention, the inspection device further comprises a drive motor, for driving fix element to rotate around rotation axis.

The efficacy of the present invention is that to be distinguished from the state of the art. The inspection device for glass substrate cassette according to the present invention comprises a plurality of inspection units disposed vertically so as to simultaneously perform inspection on a plurality of support surfaces of cassette disposed vertically. The inspection time is reduced, and efficiency and productivity are improved.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the application of the first embodiment of the inspection device for glass substrate cassette to inspect glass substrate cassette according to the present invention;

FIG. 2 is a schematic view showing optical path of glass substrate inspection of an inspection unit of the inspection device for glass substrate cassette as shown in FIG. 1;

FIG. 3 is a schematic view showing the application of the second embodiment of the inspection device for glass substrate cassette to inspect glass substrate cassette according to the present invention;

FIG. 4 is a top view of inspection device inspecting glass substrate cassette according to FIG. 3;

FIG. 5 is a schematic view showing the application of the third embodiment of the inspection device for glass substrate cassette to inspect glass substrate cassette according to the present invention; and

FIG. 6 is a top view of inspection device inspecting glass substrate cassette according to FIG. 5.

### DETAILED DESCRIPTION OF THE PREFERRED EMBODIMENTS

The following refers to drawings and embodiments of the present invention.

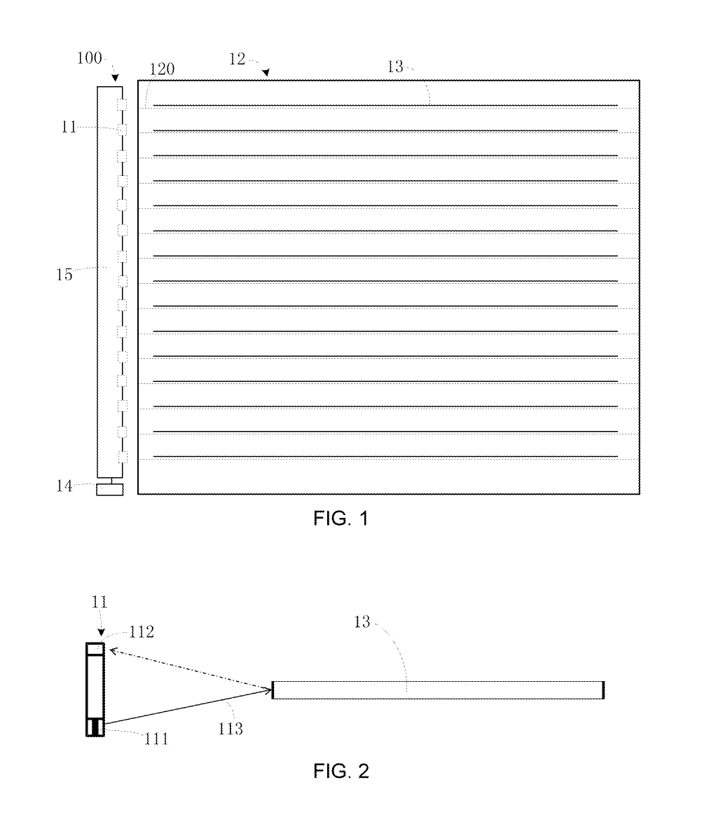

Referring to FIG. 1, FIG. 1 is a schematic view showing the application of the first embodiment of the inspection device 100 for glass substrate cassette to inspect glass substrate cassette according to the present invention. As shown in FIG. 1, cassette 12 is disposed with a plurality of support surfaces 120 vertically to support glass substrates 13.

Inspection device 100 comprises a plurality of inspection units 11, vertically disposed and corresponding to the plurality of support surfaces 120 to perform simultaneously inspection on each support surface 120 whether a glass substrate 13 is loaded on corresponding support surface 120, and whether an abnormal situation of glass substrate 13 on support surface 120 has occurred.

Also refer to FIG. 2. In the instant embodiment, inspection unit 11 is a reflective inspector. Each inspection unit comprises a light-projecting part 111 and a light-receiving part 112. Light-projecting part 111 is for projecting inspection light 113 to inspection location on corresponding support surface 120, and light-receiving part 112 is for receiving inspection light reflected by inspection location. Inspection device 100 further comprises a processing unit 14, for judging whether reflected inspection light received by light-receiving part 112 is within a predefined range.

In actual application, each support surface 120 is loaded with a glass substrate 13. When some of support surfaces are not loaded with glass substrates, the vacancy will cause increase in storage and moving cost. When glass substrate 13 is not properly stored, two or more glass substrates 13 can be loaded onto a support surface 120, which may result in scratch or crash during storage, moving and retrieval. Therefore, the above two abnormal situations are not allowed to occurred.

When support surface 120 is loaded with a glass substrate 13, inspection light 113 projected by light-projecting part 111 of inspection unit 11 can reach side wall (not shown) of glass substrate 13, and a part of inspection light 113 is reflected and received by light-receiving part 112. Information of within the predefined range is further fed back to processing unit 14.

When support surface 120 is not loaded with a glass substrate 13, inspection light 113 projected by light-projecting part 111 of inspection unit 11 cannot reach side wall of glass substrate 13, and no part of inspection light 113 is reflected and received by light-receiving part 112. Information of out of the predefined range is further fed back to processing unit 14. Processing unit 14 displays the abnormal information and further feedbacks to other execution mechanism, such as an alarm unit (not shown).

When support surface 120 is loaded with more than one glass substrates 13, inspection light 113 projected by light-projecting part 111 of inspection unit 11 cannot reach side walls of more than one glass substrates 13, inspection area becomes larger. Because inspection location receives more inspection light 113, the part of inspection light 113 reflected and received by light-receiving part 112 is also larger, and exceeds the predefined range. Information of out of the predefined range is further fed back to processing unit 14. Processing unit 14 displays the abnormal information and further feedbacks to other execution mechanism.

In the instant embodiment, inspection information by all inspection units 11 are synchronously fed back to processing unit 14, and processing unit 14 processes all inspection information and feedbacks to other execution mechanism accordingly. For example, a monitor can display all inspection information, specifically, first row: normal, second: missing substrate, third row: extra substrate, . . . and so on. The above example is only illustrative, not restrictive.

In the instant embodiment, inspection device 100 further comprises a fix element 15. Fix element 15 is located on outer side of cassette 12, and is for fixing plurality of inspection units 11 along vertical direction. Inspection units 11 fixed by fix element 15 are convenient to move and install, and have a wider application. In actual application, processing unit 14 can also be fixed by fix element 15 so that the entire inspection device 100 can be an integral entity.

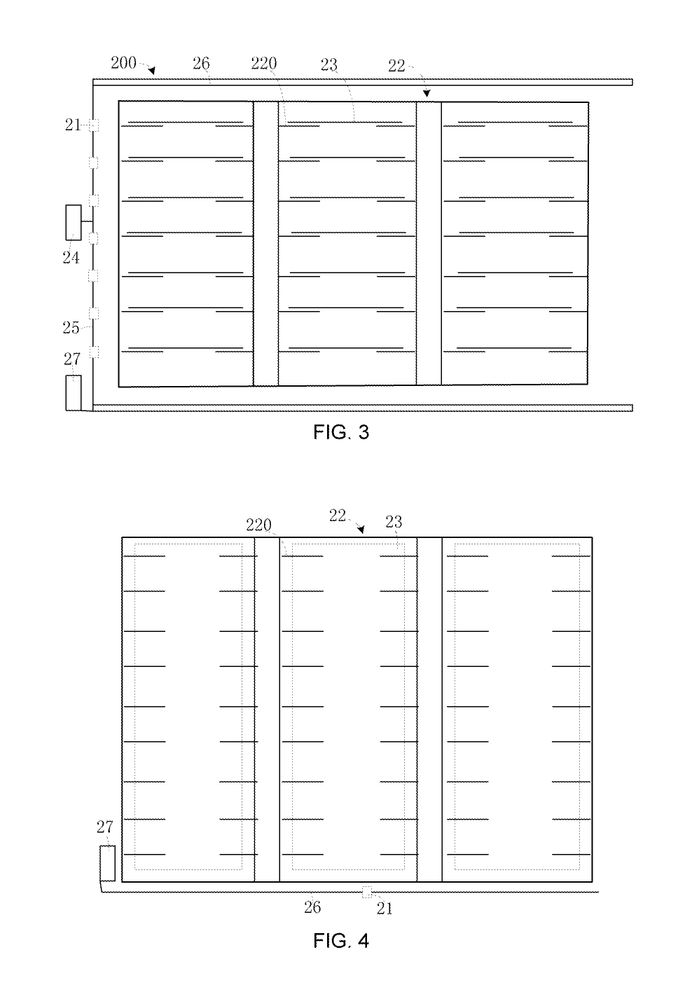

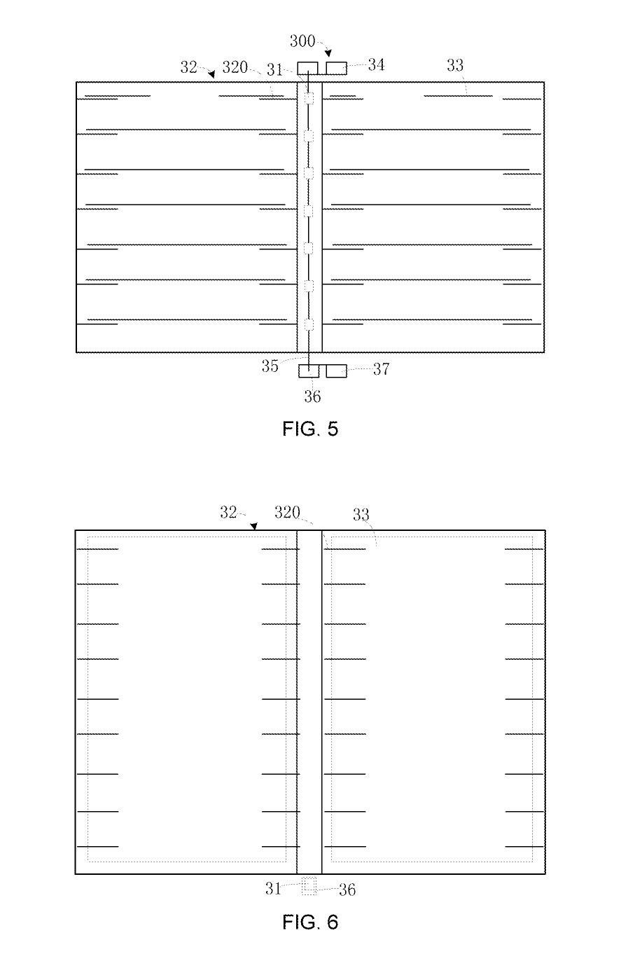

Inspection device 100 of the present embodiment can inspect a cassette 12 having a set of plurality of support surfaces 120 disposed in horizontal direction in a single run. Refer to FIG. 3 and FIG. 5. When applying inspection device 100 of the present embodiment to inspect cassettes 22, 32 having two or more sets of plurality of support surfaces 220 disposed in horizontal direction, inspection device 100 or cassettes 22, 32 must be moved to perform inspection each set separately. For application to the above scenario, the present invention further provides a second embodiment of inspection device 200 for glass substrate cassette and a third embodiment of inspection device 300 for glass substrate cassette.

Refers to FIGS. 3-4. The second embodiment of inspection device 200 for glass substrate cassette of the present invention can inspect cassettes 22, 32 having two or more sets of support surfaces 220, 320 disposed along first horizontal direction. In the instant embodiment, the description refers to inspection device 200 for glass substrate cassette inspecting cassette 220.

Inspection device 200 comprises a plurality of inspection units 21, processing unit 24, fix element 25, horizontal slide track 26 and drive motor 27.

Inspection units 21, processing unit 24 and fix element 25 are identical with the corresponding elements described in the first embodiment; thus the description is omitted here.

Horizontal slide track 26 is located on outer side of cassette 22, disposed along first horizontal direction. Fix element 25 is slidably fixed to horizontal slide track 26 so that a plurality of inspection units 21 can inspect each set of support surfaces sequentially.

Fix element 25 is driven by driving motor 27 to slide relatively to horizontal slide track 26. For more stable sliding of fix element 25, two horizontal slide tracks 26 are disposed at different height in the instant embodiment. Two horizontal slide tracks 26 are parallel and located within the same vertical plane. In actual application, number of horizontal slide tracks can be one or even more.

Refers to FIGS. 5-6. The second embodiment of inspection device 300 for glass substrate cassette of the present invention is used to inspect cassettes 32 having two sets of support surfaces 320 disposed along first horizontal direction.

Inspection device 300 comprises a plurality of inspection units 31, processing unit 34, fix element 35, rotation support device 36 and drive motor 37.

Inspection units 31, processing unit 34 and fix element 35 are identical with the corresponding elements described in the first embodiment; thus the description is omitted here.

Fix element 35 is supported by rotation support device 36 and can rotate around a vertically disposed rotation axis so that a plurality of inspection units 31 can inspect each set of support surfaces 320 sequentially. Drive motor 37 drives fix element 35 to rotate around rotation axis.

In the instant embodiment, rotation support device 36 simultaneously supports top and bottom of fix element 35 along vertical direction, and fix element 35 rotates around vertically disposed rotation axis. The rotation axis is fix element 35 itself. Drive motor 37 drives fix element 35 to rotate around own vertical center line.

In actual application, rotation support device 36 can also be rotation axis for fix element 35, and vertical center line of rotation support device 36 is in parallel with vertical center line of fix element 35. Drive motor 37 drives rotation support device 36 to rotate. With linkage movement by rotation support device 36, fix element 35 rotates with rotation support device 36.

The efficacy of the present invention is that to be distinguished from the state of the art. The inspection devices 100, 200, 300 for glass substrate cassette according to the present invention comprise a plurality of inspection units 11, 21, 31, disposed vertically so as to simultaneously perform inspection on a plurality of support surfaces 120, 220, 320 of cassettes 12, 22, 32 disposed vertically. The inspection time is reduced, and efficiency and productivity are improved.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. An inspection device for glass substrate cassette, the glass substrate cassette being disposed vertically with a plurality of support surfaces for supporting glass substrate, which comprises: a plurality of inspection units, vertically disposed and corresponding to the plurality of support surfaces to perform inspection simultaneously on each support surface whether a glass substrate being loaded on corresponding support surface, and whether a double-loading having occurred; each inspection unit comprising a light-projecting part and a light-receiving part; the light-projecting part for projecting inspection light to inspection location on corresponding support surface, and the light-receiving part for receiving inspection light reflected by inspection location; inspection device further comprising a processing unit, for judging whether reflected inspection light being within a predefined range; the inspection device further comprising a fix element, for fixing plurality of inspection units along vertical direction.

2. The inspection device as claimed in claim 1, characterized in that the fix element is located on the outer side of the cassette.

3. The inspection device as claimed in claim 1, characterized in that the cassette is disposed with at least two sets of plurality of support surfaces along the horizontal direction, and the inspection device further comprises at least a horizontal slide track, with fix element slidably fixed to the horizontal slide track so that a plurality of inspection units is able to inspect each set of plurality of support surfaces sequentially.

4. The inspection device as claimed in claim 3, characterized in that the inspection device further comprises a drive motor, for driving fix element to slide along horizontal slide track.

5. The inspection device as claimed in claim 4, characterized in that number of horizontal slide tracks is two, and two horizontal slide tracks are disposed in parallel and within same vertical plane.

6. The inspection device as claimed in claim 1, characterized in that the cassette is disposed with at least two sets of plurality of support surfaces along the horizontal direction, and the inspection device further comprises a rotation support device, with fix element supported by the rotation support device and able to rotate around vertically disposed rotation axis so that a plurality of inspection units is able to inspect each set of plurality of support surfaces sequentially.

7. The inspection device as claimed in claim 6, characterized in that the rotation support device simultaneously supports top and bottom of fix element along vertical direction.

8. The inspection device as claimed in claim 6, characterized in that the inspection device further comprises a drive motor, for driving fix element to rotate around rotation axis.

9. An inspection device for glass substrate cassette, the glass substrate cassette being disposed vertically with a plurality of support surfaces for supporting glass substrate, which comprises a plurality of inspection units, vertically disposed and corresponding to the plurality of support surfaces to perform inspection simultaneously on each support surface whether a glass substrate being loaded on corresponding support surface, and whether an abnormal situation of glass substrate having occurred.

10. The inspection device as claimed in claim 9, characterized in that each inspection unit comprises a light-projecting part and a light-receiving part; the light-projecting part for projecting inspection light to inspection location on corresponding support surface, and the light-receiving part for receiving inspection light reflected by inspection location; and the inspection device further comprising a processing unit, for judging whether reflected inspection light being within a predefined range.

11. The inspection device as claimed in claim 9, characterized in that the inspection device further comprises a fix element, for fixing plurality of inspection units along vertical direction.

12. The inspection device as claimed in claim 11, characterized in that the fix element is located on the outer side of the cassette.

13. The inspection device as claimed in claim 11, characterized in that the cassette is disposed with at least two sets of plurality of support surfaces along the horizontal direction, and the inspection device further comprises at least a horizontal slide track, with fix element slidably fixed to the horizontal slide track so that a plurality of inspection units is able to inspect each set of plurality of support surfaces sequentially.

14. The inspection device as claimed in claim 13, characterized in that the inspection device further comprises a drive motor, for driving fix element to slide along horizontal slide track.

15. The inspection device as claimed in claim 14, characterized in that number of horizontal slide tracks is two, and two horizontal slide tracks are disposed in parallel and within same vertical plane.

16. The inspection device as claimed in claim 11, characterized in that the cassette is disposed with at least two sets of plurality of support surfaces along the horizontal direction, and the inspection device further comprises a rotation support device, with fix element supported by the rotation support device and able to rotate around vertically disposed rotation axis so that a plurality of inspection units is able to inspect each set of plurality of support surfaces sequentially.

17. The inspection device as claimed in claim 16, characterized in that the rotation support device simultaneously supports top and bottom of fix element along vertical direction.

18. The inspection device as claimed in claim 16, characterized in that the inspection device further comprises a drive motor, for driving fix element to rotate around rotation axis.
